(19) United States
(12) Patent Application Publication
(10) Pub. No.: US 2010/0004936 A1
(43) Pub. Date: Jan. 7, 2010

(54) AUDIO OUTPUT APPARATUS CAPABLE OF SUPPRESSING POP NOISE

(76) Inventor: Chun-Chen Chao, Taipei City (TW)

Correspondence Address: POTTER ANDERSON & CORROON LLP;ATTN: JANET E. REED, PH.D., P.O. BOX 951, WILMINGTON, DE, 19899-0951, US

(21) Appl. No.: 12/338,622

(22) Filed: Dec. 18, 2008

(30) Foreign Application Priority Data
Jul. 4, 2008 (TW) 097125242

(51) Int. Cl. G10L 21/00

(52) U.S. Cl. 704/500; 704/E21.001

(57) ABSTRACT

An audio output apparatus includes an audio codec receiving a digital audio signal from a system controller and outputting an analog audio signal corresponding to the digital audio signal to an amplifier through a capacitor, and a switch controller triggered by a trigger signal to output a control signal to the amplifier. The amplifier is disabled to cease outputting the analog audio signal in response to the control signal. The trigger signal is generated by one of the system controller, the audio codec, and a power circuit supplying electric power to the system controller, the audio codec, the switch controller and the amplifier upon occurrence of a condition associated with pop noise, and is outputted to the switch controller before the pop noise is generated, such that the amplifier is disabled in response to the control signal from the switch controller and is unable to output the pop noise.

### CROSS-REFERENCE TO RELATED APPLICATION

This application claims priority of Taiwanese Application No. 097125242, filed on Jul. 4, 2008.

### BACKGROUND OF THE INVENTION

1. Field of the Invention

The invention relates to an audio output apparatus, more particularly to an audio output apparatus capable of suppressing pop noise.

2. Description of the Related Art

FIG. 1 illustrates a conventional audio output apparatus disclosed in U.S. Patent Application Publication No. 2008/0049952. The conventional audio output apparatus includes an audio codec 21 for receiving and processing a digital audio signal and for outputting an analog audio signal corresponding to the digital audio signal to a speaker 26 through a capacitor 22, and a capacitor charger 24 including a pulse generator 241 and an integrating circuit 242 for smoothly charging the capacitor 22 to a predetermined voltage level via a switch 25 arranged between the capacitor charger 24 and the junction of an output end of the audio codec 21 and the capacitor 22 and the capacitor charger 24. A control unit 23 turns on the switch 25 and drives the capacitor charger 24 to charge the capacitor 22 before activating the audio codec 21, and then turns off the switch 25 and terminates the operation of the capacitor charger 24 after a predetermined charging time has elapsed.

However, such an audio output apparatus cannot suppress output of pop noise attributed to activation or deactivation of internal functionality of the audio codec 21.

Referring to FIG. 2, another conventional audio output apparatus is shown to include an audio codec 32 for receiving and processing a digital audio signal from a system controller 31 and for outputting an analog audio signal corresponding to the digital audio signal to an amplifier 34 through a capacitor 33, and a control circuit 35 including a timing capacitor 351, a timing resistor 352 and two transistors 353, 354, and operable to deactivate the amplifier 34, i.e., a voltage (V_{CC2}) supplied to the amplifier 34 being zero, in response to a control signal. As such, pop noise attributed to activation of the audio codec 32 is not outputted to an external audio reproduction device (not shown) because the control circuit 35 deactivates the amplifier 34 during occurrence of the pop noise.

However, the transistor 354 is required to permit flowing of a relatively large amount of current therethrough, thereby resulting in a relatively high cost. Furthermore, since a voltage drop is generated at the transistor 354, the voltage (V_{CC2}) is reduced. On the other hand, if the amplifier 34 is a headphone amplifier, even though the voltage (V_{CC2}) is zero during occurrence of pop noise, the pop noise is conducted to the external audio reproduction device through the amplifier 34 that serves as a resistor.

### SUMMARY OF THE INVENTION

Therefore, an object of the present invention is to provide an audio output apparatus that is capable of suppressing pop noise and that can overcome the aforesaid drawbacks of the prior art.

According to the present invention, an audio output apparatus comprises:

a system controller for outputting a digital audio signal;

an audio codec coupled to the system controller for receiving the digital audio signal therefrom and for outputting an analog audio signal corresponding to the digital audio signal;

a capacitor having one end coupled to the audio codec;

an amplifier having an input end coupled to the other end of the capacitor for receiving the analog audio signal from the audio codec through the capacitor, a control input end, and an output end, the amplifier being disabled to cease outputting the analog audio signal at the output end in response to a control signal received at the control input end;

a switch controller coupled to the control input end of the amplifier, the switch controller being triggered by a trigger signal to generate the control signal and outputting the control signal to the control input end of the amplifier; and

a power circuit for supplying electric power to the system controller, the audio codec, the switch controller and the amplifier.

The trigger signal is generated by one of the system controller, the audio codec and the power circuit upon occurrence of a condition associated with pop noise, and is outputted to the switch controller before the pop noise is generated, such that the amplifier is disabled in response to the control signal from the switch controller, and is unable to output the pop noise.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic electrical circuit block diagram of a conventional audio output apparatus;

FIG. 2 is a schematic electrical circuit block diagram of another conventional audio output apparatus;

FIG. 3 is a schematic electrical circuit block diagram illustrating the preferred embodiment of an audio output apparatus according to the present invention;

FIG. 4 is a schematic electrical circuit diagram showing a switch controller of the preferred embodiment;

FIGS. 5I and 5II are timing diagrams of electric power signals supplied to a system controller and an audio codec of the preferred embodiment;

FIGS. 5III and 5IV are timing diagrams illustrating pop noise, and the disabled duration of an amplifier of the preferred embodiment;

FIG. 5V is a timing diagram of a trigger signal for the switch controller;

FIGS. 5VI, 5VII and 5VIII are timing diagrams of signals at nodes A, B, and C/D of the switch controller shown in FIG. 4; and

FIG. 5IX is a timing diagram of a control signal for the amplifier of the preferred embodiment.

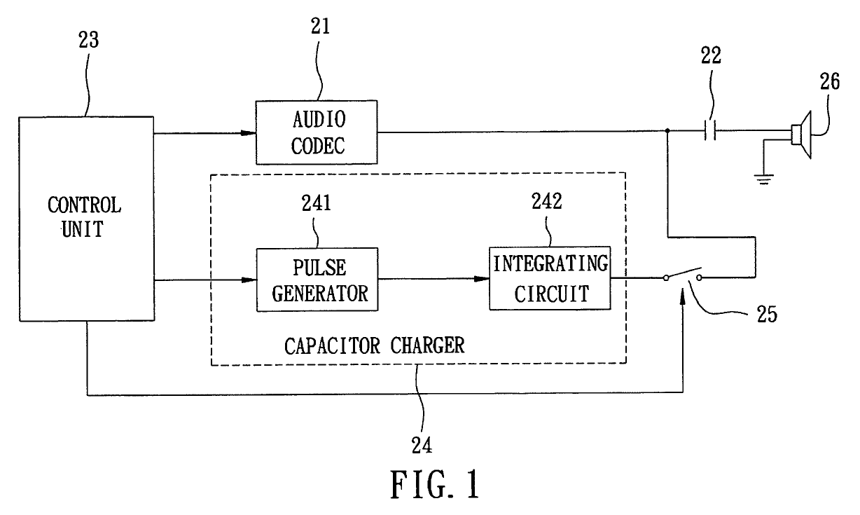

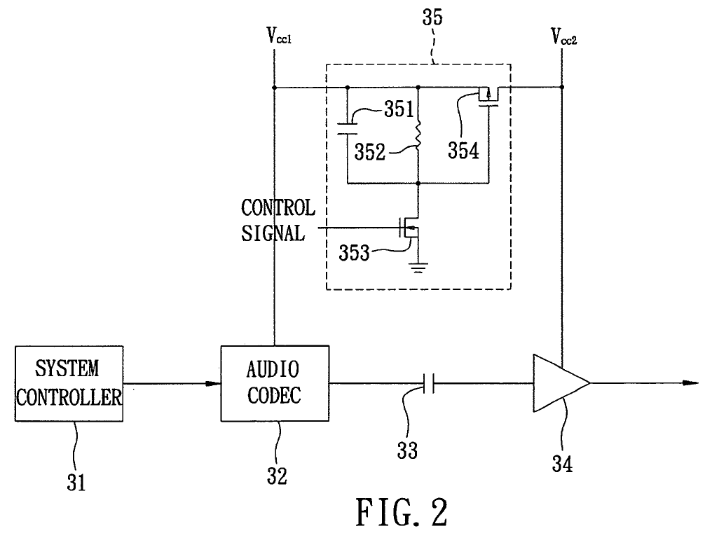

### DETAILED DESCRIPTION OF THE PREFERRED EMBODIMENT

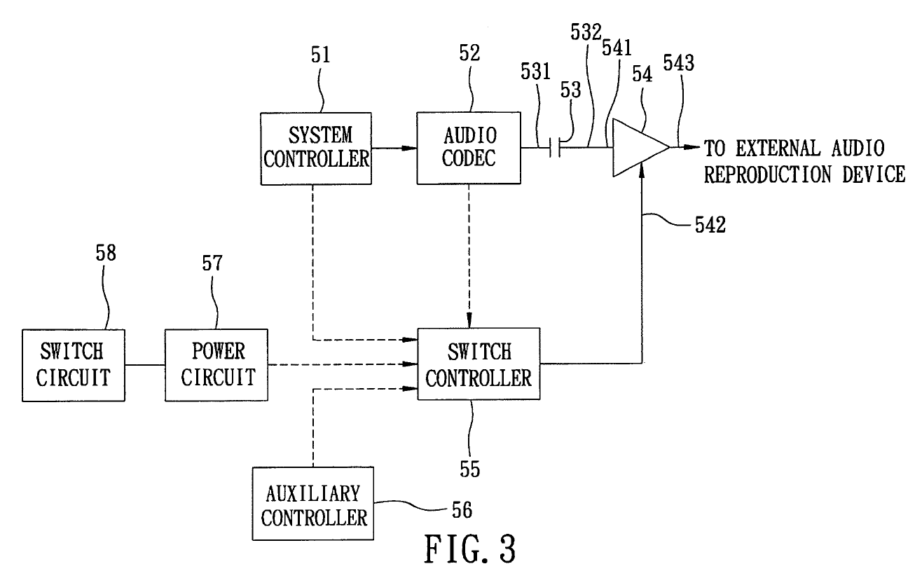

Referring to FIG. 3, the preferred embodiment of an audio output apparatus according to the present invention is shown to include a system controller 51, an audio codec 52, a capacitor 53, an amplifier 54, a switch controller 55, a power circuit 57, and an auxiliary controller 56.

The system controller 51 outputs a digital audio signal.

The audio codec 52 is coupled to the system controller 51 for receiving the digital audio signal therefrom and for outputting an analog audio signal corresponding to the digital audio signal.

The capacitor 53 has one end 531 coupled to the audio codec 52.

The amplifier 54 has an input end 541 coupled to the other end 532 of the capacitor 53 for receiving the analog audio signal from the audio codec 52 through the capacitor 53, a control input end 542, and an output end 543 adapted to be coupled to an external audio reproduction device (not shown) The amplifier 54 is disabled to cease outputting the analog audio signal at the output end 543 in response to a control signal received at the control input end 542. It is noted that the amplifier 54 is operated in one of a mute mode and a shutdown mode when the amplifier 54 is disabled.

The switch controller 55 is coupled to the control input end 542 of the amplifier 54. The switch controller 55 is trigged by a trigger signal to generate the control signal, and outputs the control signal to the control input end 542 of the amplifier 54.

The power circuit 57 supplies electric power to the system controller 51, the audio codec 52, the switch controller 55 and the amplifier 54. In this embodiment, a switch circuit 58 is coupled to the power circuit 57, and is operable to switch between an ON mode and an OFF mode.

The auxiliary controller 56 is an embedded controller in this embodiment, and is coupled to the switch controller 55.

In this embodiment, the audio output apparatus is a notebook computer installed with Microsoft Windows® operating system. In other embodiment, the audio output apparatus can be a personal digital assistant, a mobile phone, a personal computer, a tablet PC or a UMPC, which can be installed with Linux or DOS operating system. For such an audio output apparatus, pop noise results from occurrence of any one of the following: the audio output apparatus is turned on; the audio output apparatus is reset; the audio output apparatus goes into a standby mode (S3); the audio output apparatus switches from the standby mode; the audio output apparatus goes into a sleep mode (S4); the audio output apparatus wakes up from the sleep mode; the audio output apparatus is abnormally shut down; and the switch circuit 58 is switched from one of the ON mode and the OFF mode to the other one of the ON mode and the OFF mode. More specifically, when the audio output apparatus is turned on, is reset, switches from the standby mode or wakes up from the sleep mode, the audio codec 52 is activated such that the capacitor 53 is charged. Thereafter, when internal functionality of the audio codec 52 is turned on, pop noise is generated. On the other hand, when the audio output apparatus goes into the standby mode, goes into the sleep node or is abnormally shut down, the internal functionality of the audio code 52 is turned off and then, the audio codec 52 is deactivated such that the capacitor 53 discharges, thereby resulting in pop noise.

It is noted that the trigger signal is generated by at least one of the system controller 51, the audio codec 52, the power circuit 57 and the auxiliary controller 56 upon occurrence of a condition associated with pop noise, and is outputted to the switch controller 55 before the pop noise is generated, such that the amplifier 54 is disabled in response to the control signal from the switch controller 55 and is unable to output the pop noise.

In this embodiment, ideally, the system controller 51 outputs the trigger signal upon occurrence of any one of the following: the audio output apparatus is turned on; the audio output apparatus is reset; the audio output apparatus switches from the standby mode; and the audio output apparatus wakes up from the sleep mode. The audio codec 52 outputs the trigger signal upon occurrence of any one of the following: the audio output apparatus goes into the standby mode; the audio output apparatus goes into the sleep mode; and the audio output apparatus is abnormally shut down. The power circuit 57 outputs the trigger signal when the switch circuit 58 is switched from one of the ON mode and the OFF mode to the other one of the ON mode and the OFF mode. As a result, the auxiliary controller 56 is optional. However, in case one of the system controller 51, the audio codec 52 and the power circuit 57 is unable to supply the trigger signal to the switch controller 55 (such as due to non-availability of a suitable pin for transmitting the trigger signal) or one of the system controller 51, the audio codec 52 and the power circuit 57 is unable to output the trigger signal at appropriate times, the auxiliary controller 56 outputs the trigger signal to the switch controller 55 upon occurrence of the condition using firmware.

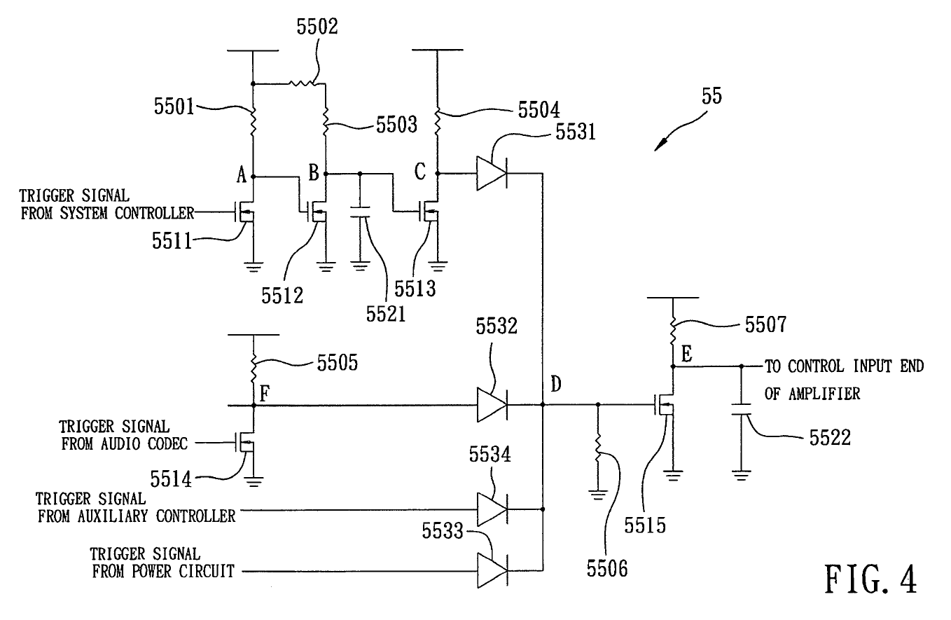

Referring further to FIG. 4, in this embodiment, the switch controller 55 includes seven resistors 5501˜5507, five transistors 5511˜5515, two capacitors 5521, 5522, and four diodes 5531˜5534, wherein: a node (A) between the resistor 5501 and the transistor 5511 is coupled to a gate of the transistor 5512; a node (B) among the resistor 5503, the transistor 5512 and the capacitor 5521 is coupled to a gate of the transistor 5513; a node (C) between the resistor 5504 and the transistor 5513 is coupled to a node (D) among cathodes of the diodes 5532, 5534, 5533, the resistor 5506, and a gate of the transistor 5515 via the diode 5531; a node (E) among the resistor 5507, the transistor 5515 and the capacitor 5522 is coupled to the control input end 542 of the amplifier 54; a gate of the transistor 5511 is coupled to the system controller 51; a node (F) between the resistor 5505 and the transistor 5514 is coupled to the node (D) via the diode 5532; a gate of the transistor 5514 is coupled to the audio codec 52; an anode of the diode 5533 is coupled to the power circuit 57; and an anode of the diode 5534 is coupled to the auxiliary controller 56. It is noted that the resistors 5502, 5503, 5507 and the capacitors 5521, 5522 are timing resistors and timing capacitors. The duration during which the amplifier 54 is disabled is associated with the timing resistors and the timing capacitors.

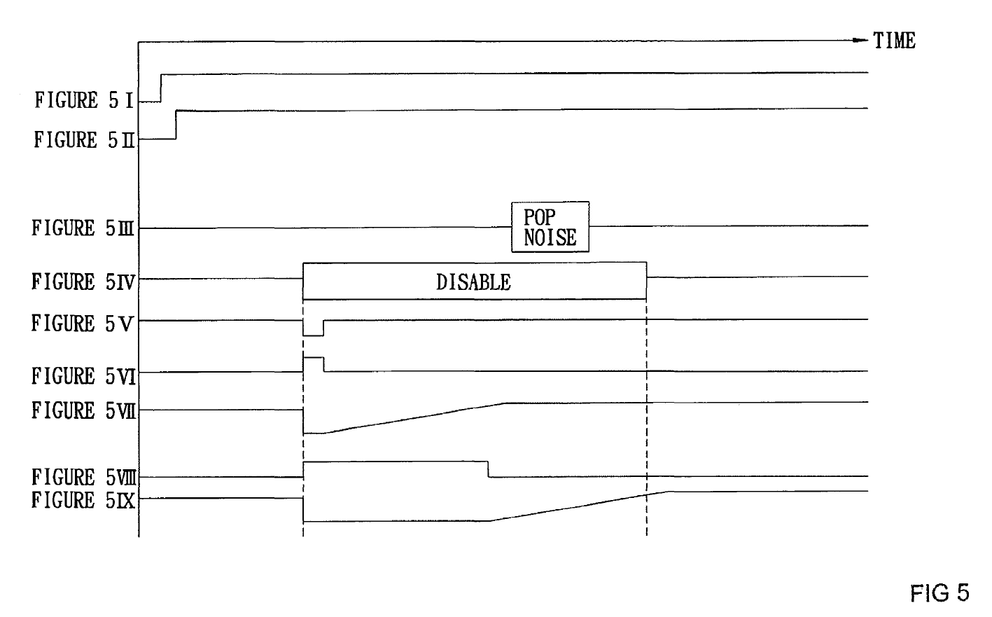

Referring further to FIGS. 5I to 5IX, for example, when the audio output apparatus is turned on, an electric power signal shown in FIG. 5I is supplied to the system controller 51, and then, the audio codec 52 is activated with an electric power signal shown in FIG. 5II. Thereafter, when the audio output apparatus is reset, switches from the standby mode or switches from the sleep mode, the system controller 51 outputs the trigger signal shown in FIG. 5V to the switch controller 55 before pop noise attributed to activation of the internal functionality of the audio codec 52, as shown in FIG. 5III, is generated. As for operation of the switch controller 55, a signal at the node (A) is shown in FIG. 5VI; a signal at the node (B) is shown in FIG. 5VII; a signal at the node (C/D) is shown in FIG. 5VIII; and the control signal, i.e., a signal at the node (E), is shown in FIG. 5IX. As a result, the amplified 54 is disabled in response to the control signal from the switch controller 55 within the duration shown in FIG. 5IV. Thus, the pop noise can be effectively suppressed.

In sum, since the trigger signal is outputted to the switch controller 55 by one of the system controller 51, the audio codec 52, the power circuit 57 and the auxiliary controller 56 upon occurrence of the condition associated with pop noise, the switch controller 55 outputs the control signal to the amplifier 54 in response to the trigger signal before pop noise is generated, such that the amplifier 54 is disabled in response to the control signal from the switch controller 55 and is unable to output the pop noise. Thus, the audio output apparatus of the present invention can effectively prevent the pop noise from being outputted at the output end 543 of the amplifier 54.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. An audio output apparatus comprising:
a system controller for outputting a digital audio signal;
an audio codec coupled to said system controller for receiving the digital audio signal therefrom and for outputting an analog audio signal corresponding to the digital audio signal;
a capacitor having one end coupled to said audio codec;
an amplifier having an input end coupled to the other end of said capacitor for receiving the analog audio signal from said audio codec through said capacitor, a control input end, and an output end, said amplifier being disabled to cease outputting the analog audio signal at said output end in response to a control signal received at said control input end;
a switch controller coupled to said control input end of said amplifier, said switch controller being triggered by a trigger signal to generate the control signal and outputting the control signal to said control input end of said amplifier; and
a power circuit for supplying electric power to said system controller, said audio codec, said switch controller and said amplifier;
wherein the trigger signal is generated by one of said system controller, said audio codec and said power circuit upon occurrence of a condition associated with pop noise, and is outputted to said switch controller before the pop noise is generated, such that said amplifier is disabled in response to the control signal from said switch controller and is unable to output the pop noise.

2. The audio output apparatus as claimed in claim 1, wherein said switch controller includes at least one timing resistor and at least one timing capacitor, the duration during which said amplifier is disabled being associated with said timing resistor and said timing capacitor.

3. The audio output apparatus as claimed in claim 1, wherein said amplifier is operated in one of a mute mode and a shutdown mode when said amplifier is disabled.

4. The audio output apparatus as claimed in claim 1, further comprising an auxiliary controller for outputting the trigger signal to said switch controller upon occurrence of the condition.

5. The audio output apparatus as claimed in claim 4, wherein one of said system controller and said auxiliary controller outputs the trigger signal upon occurrence of one of the following: said audio output apparatus is turned on; said audio output apparatus is reset; said audio output apparatus switches from a standby mode; and said audio output apparatus wakes up from a sleep mode.

6. The audio output apparatus as claimed in claim 4, wherein one of said audio codec and said auxiliary controller outputs the trigger signal upon occurrence of one of the following: said audio output apparatus goes into a standby mode; said audio output apparatus goes into a sleep mode; and said audio output apparatus is abnormally shut down.

7. The audio output apparatus as claimed in claim 4, further comprising a switch circuit coupled to said power circuit and controlled by said power circuit to switch between an ON mode and an OFF mode;
wherein one of said power circuit and said auxiliary controller outputs the trigger signal when said switch circuit is switched from one of the ON mode and the OFF mode to the other one of the ON mode and the OFF mode.

8. The audio output apparatus as claimed in claim 4, wherein said switch controller includes four diodes having cathodes coupled to each other, and anodes corresponding respectively to said system controller, said audio codec, said power circuit and said auxiliary controller.

9. The audio output apparatus as claimed in claim 4, wherein said auxiliary controller is an embedded controller.
